(19) United States
(12) Patent Application Publication
(10) Pub. No.: US 2015/0120867 A1
(43) Pub. Date: Apr. 30, 2015

(54) APPARATUS AND METHOD FOR TRANSMITTING DATA COLLECTED FROM SMART DEVICE

(71) Applicant: Electronics and Telecommunications Research Institute, Daejeon (KR)

(72) Inventors: Seungwoog JUNG, Daejeon (KR); Yunkyung PARK, Daejeon (KR); Jonghyun PARK, Daejeon (KR)

(21) Appl. No.: 14/503,484

(22) Filed: Oct. 1, 2014

(30) Foreign Application Priority Data
Oct. 25, 2013 (KR) 10-2013-0127793

(51) Int. Cl. H04L 29/08; H04L 12/26

(52) U.S. Cl. CPC H04L 67/06; H04L 67/1095; H04L 43/065
USPC 709/217

(57) ABSTRACT

The device for transmitting data includes a data collection unit, a first data extraction unit, a monitoring unit, a second data extraction unit, and a data transmission unit. The data collection unit collects data generated in a smart device. The first data extraction unit extracts data corresponding to data extraction conditions preset by the user of the smart device from the data collected by the data collection unit. The monitoring unit monitors the state of the smart device. The second data extraction unit extracts data corresponding to data transmission conditions preset by the user of the smart device based on the results of the monitoring of the monitoring unit from the data extracted by the first data extraction unit. The data transmission unit transmits data extracted by the second data extraction unit to a data server.

### CROSS-REFERENCE TO RELATED APPLICATION

This application claims the benefit of Korean Patent Application No. 10-2013-0127793, filed Oct. 25, 2013, which is hereby incorporated by reference herein in its entirety.

### BACKGROUND OF THE INVENTION

1. Technical Field

The present disclosure relates generally to an apparatus and method for transmitting data collected from a smart device and, more particularly, to an apparatus and method for transmitting data collected from a smart device, which extract data from data collected from a smart device based on conditions previously set by a user and the state of the smart device and then transmit the extracted data to a data server.

2. Description of the Related Art

With the widespread popularization of smart devices, services that collect data generated in smart devices and then provide various functions based on the collected data have appeared.

A representative service thereof is SNS applications. Social Network Service (SNS) applications are a service that enables information collected by individuals to be shared with other people via the Internet, and are recently becoming widespread thanks to the high popularization of smart devices and the mobile Internet.

Such SNS applications have the advantages of the sharing of content between users, the formation of social networks, communication with various people, and the implementation of on-line interest groups, as disclosed in Korean Patent Application Publication No. 2011-0052137. However, SNS applications cause side effects, such as the invasion of privacy attributable to the excessive divulgence of personal information, phishing attacks between users, and new social network stress attributable to deep infiltration into the private lives of users.

Accordingly, although corporations that provide SNS applications filter data transmitted from smart devices in order to protect private information, this method is disadvantageous in that excessive processing time is required and excessive cost is incurred. As a result, there is a recent need for a method by which a smart device can exclude privacy-related data and transmit only data allowed by a user.

### SUMMARY OF THE INVENTION

Embodiments of the present invention are directed to an apparatus and method for transmitting data collected from a smart device, which extract data from data collected from the smart device based on data extraction conditions and data transmission conditions previously set by a user and then transmit the extracted data to a data server.

Embodiments of the present invention are directed to an apparatus and method for transmitting data collected from a smart device, which provide data extraction conditions set such that they are used to distinguish between the types of data that are allowable for transmission to the data server and the types of data that are disallowable for transmission to the data server and the data transmission conditions that are set such that they are used to distinguish between the types of data that can be transmitted to the data server and the types of data that cannot be transmitted to the data server, based on the results of the monitoring.

In accordance with an aspect of the present invention, there is provided a device for transmitting data collected from a smart device, including a data collection unit configured to collect data generated in a smart device; a first data extraction unit configured to extract data corresponding to data extraction conditions preset by the user of the smart device from the data collected by the data collection unit; a monitoring unit configured to monitor a state of the smart device; a second data extraction unit configured to extract data corresponding to data transmission conditions preset by the user of the smart device based on the results of the monitoring of the monitoring unit from the data extracted by the first data extraction unit; and a data transmission unit configured to transmit data extracted by the second data extraction unit to a data server.

The data collection unit may collect data including at least any one of location data collected via a Global Positioning System (GPS) of the smart device, sensor data collected from a sensor attached to the smart device, still or moving image data collected from a camera module contained in the smart device, voice data, text message data, call record data, address book data, and e-mail data.

The data extraction conditions may be conditions that are set such that they are used to distinguish between the types of data that are allowable for transmission to the data server and the types of data that are disallowable for transmission to the data server.

The first data extraction unit may extract data allowable for transmission to the data server by applying the data extraction conditions.

The monitoring unit may monitor the battery level of the smart device and a communication environment.

The data transmission conditions may be conditions that are set such that they are used to distinguish between the types of data that can be transmitted to the data server and the types of data that cannot be transmitted to the data server, based on the results of the monitoring.

If, as a result of the monitoring, it is determined that a battery level of the smart device is equal to or lower than a preset threshold level or the smart device is in an unstable communication environment, the second data extraction unit may extract data that can be transmitted to the data server by applying the data transmission conditions.

In accordance with another aspect of the present invention, there is provided a method of transmitting data collected from a smart device, including collecting, by a data collection unit, data generated in a smart device; extracting, by a first data extraction unit, data corresponding to data extraction conditions preset by a user of the smart device from the data collected by the data collection unit; monitoring, by a monitoring unit, a state of the smart device; extracting, by a second data extraction unit, data corresponding to data transmission conditions preset by the user of the smart device based on results of the monitoring of the monitoring unit from the data extracted by the first data extraction unit; and transmitting, by a data transmission unit, data extracted by the second data extraction unit to a data server.

The data extraction conditions that are used upon extracting the data corresponding to the data extraction conditions preset by the user of the smart device from the data collected by the data collection unit may be conditions that are set such that they are used to distinguish between the types of data that are allowable for transmission to the data server and the types of data that are disallowable for transmission to the data server.

Extracting the data corresponding to the data extraction conditions preset by the user of the smart device from the data collected by the data collection unit may include extracting data allowable for transmission to the data server by applying the data extraction conditions.

The data transmission conditions that are used upon extracting the data corresponding to the data transmission conditions preset by the user of the smart device based on the results of the monitoring of the monitoring unit from the data extracted by the first data extraction unit may be conditions that are set such that they are used to distinguish between types of data that can be transmitted to the data server and types of data that cannot be transmitted to the data server, based on results of the monitoring.

Extracting the data corresponding to the data transmission conditions preset by the user of the smart device based on the results of the monitoring of the monitoring unit from the data extracted by the first data extraction unit may include, if, as a result of the monitoring, it is determined that a battery level of the smart device is equal to or lower than a preset threshold level or the smart device is in an unstable communication environment, extracting data that can be transmitted to the data server by applying the data transmission conditions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a device for transmitting data collected from a smart device according to an embodiment of the present invention;

FIG. 2 is a diagram illustrating the types of data collected via the device for transmitting data collected from a smart device according to an embodiment of the present invention, and data type codes;

FIG. 3 is a diagram illustrating data extraction conditions according to an embodiment of the present invention;

FIG. 4 is a diagram illustrating data transmission conditions according to an embodiment of the present invention; and

FIG. 5 is a flowchart illustrating a method of transmitting data collected from a smart device according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that the same reference numerals are used to designate the same or similar elements throughout the drawings. In the following description of the present invention, detailed descriptions of known functions and configurations which are deemed to make the gist of the present invention obscure will be omitted.

An apparatus and method for transmitting data collected from a smart device according to an embodiment of the present invention will be described in detail below with reference to the accompanying diagrams.

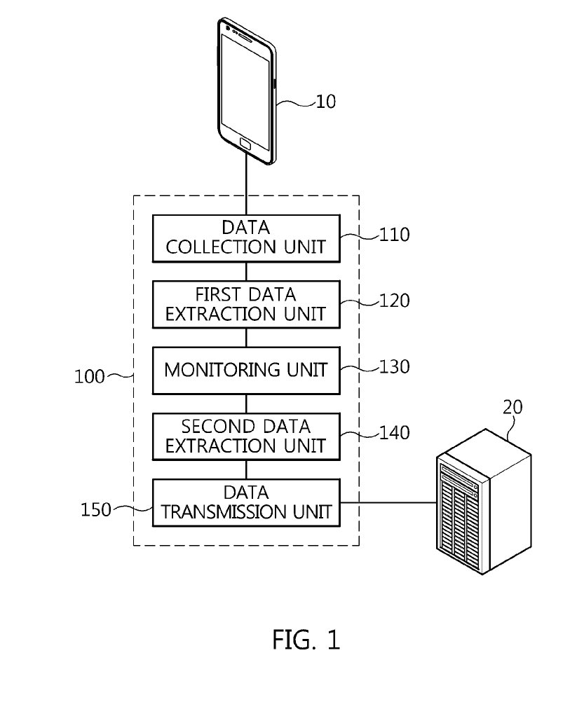

FIG. 1 is a diagram illustrating the configuration of a device 100 for transmitting data collected from a smart device according to an embodiment of the present invention.

Referring to FIG. 1, the device 100 for transmitting data collected from a smart device according to this embodiment of the present invention includes a data collection unit 110, a first data extraction unit 120, a monitoring unit 130, a second data extraction unit 140, and a data transmission unit 150. Although the device 100 for transmitting data collected from a smart device, which is configured as described above, is contained in a smart device 10, the device 100 for transmitting data collected from a smart device is illustrated as being separate from the smart device 10 in FIG. 1 for ease of description.

The data collection unit 110 collects data generated by the smart device 10. In this case, the data collection unit 110 collects data, including at least any one of location data collected via the GPS of the smart device 10, sensor data collected from a sensor attached to the smart device 10, still image (photo/image) and moving image data collected from a camera module contained in the smart device 10, text message data, voice data, call record data, address book data, and e-mail data.

The first data extraction unit 120 extracts data corresponding to data extraction conditions preset by the user of the smart device 10 from the data collected by the data collection unit 110. In this case, the data extraction conditions refer to conditions that are set such that they are used to distinguish between the types of data that are allowable for transmission to the data server 20 and the types of data that are disallowable for transmission to the data server 20. Accordingly, the first data extraction unit 120 primarily extracts data that is allowable for transmission to the data server 20 by applying the data extraction conditions.

The monitoring unit 130 monitors the state of the smart device 10. That is, the monitoring unit 130 performs monitoring by collecting information about a battery level and a communication environment from the battery and communication unit of the smart device 10.

The second data extraction unit 140 extracts data corresponding to data transmission conditions, preset by the user of the smart device 10, from the data extracted by the first data extraction unit 120 based on the results of the monitoring of the monitoring unit 130. In this case, the data transmission conditions refer to conditions that are set such that they are used to distinguish between the types of data that can be transmitted to the data server 20 and the types of data that cannot be transmitted to the data server 20, based on the results of the monitoring. Accordingly, the second data extraction unit 140, if, as a result of the monitoring, it is determined that the battery level of the smart device 10 is equal to or lower than a preset threshold level or the smart device 10 is in an unstable communication environment, secondarily extracts data that can be transmitted to the data server 20 by applying the data transmission conditions.

The data transmission unit 150 transmits the data extracted by the second data extraction unit 140 to the data server 20.

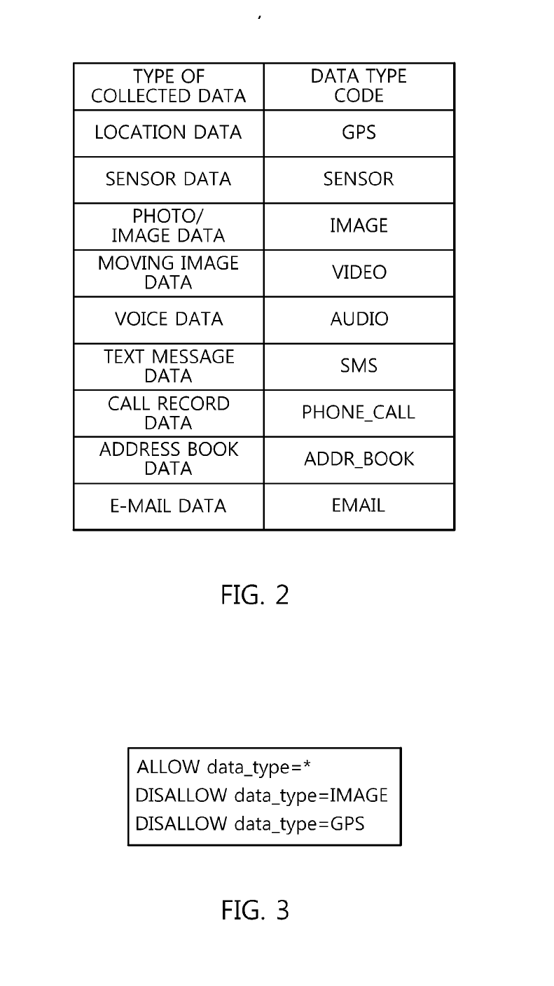

FIG. 2 is a diagram illustrating the types of data collected via the device for transmitting data collected from a smart device according to an embodiment of the present invention, and data type codes.

Referring to FIG. 2, the types of data collected according to an embodiment of the present invention include at least any one of location data, sensor data, still image (photo/image) data, moving image data, voice data, text message data, call record data, address book data and e-mail data, and a data type code for the location data is defined as “GPS,” a data type code for the sensor data is defined as “SENSOR,” a data type code for the still image (photo/image) data is defined as “IMAGE,” a data type code for the moving image data is defined as “VIDEO,” a data type code for the voice data is defined as “AUDIO,” a data type code for the text message data is defined as “SNS,” a data type code for the call record data is defined as “PHONE_CALL,” a data type code for the address book data is defined as “ADDR_BOOK,” and a data type code for the e-mail data is defined as “EMAIL.”

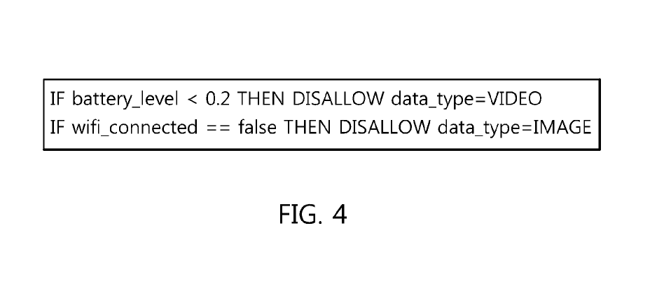

FIG. 3 is a diagram illustrating data extraction conditions according to an embodiment of the present invention, and FIG. 4 is a diagram illustrating data transmission conditions according to an embodiment of the present invention.

Referring to FIG. 3, the data extraction conditions according to this embodiment of the present invention are set by the user of a smart device. The data extraction conditions indicate the types of data allowable or disallowable for the data server using data codes, as illustrated in the diagram. FIG. 3 illustrates the data extraction conditions indicative that the still image data having the data type code “IMAGE” and the location data having the data type code “GPS” are disallowable for the data server and the other types of data are allowable for the data server.

Referring to FIG. 4, the data transmission conditions according to an embodiment of the present invention are set by the user of the smart device. In this case, each of the data transmission conditions includes a conditional statement and an executable statement. A conditional statement is indicative of a condition based on the results of the monitoring of smart device, and an executable statement is indicative of a data transmission condition. In FIG. 4, a first condition is indicative that if the battery level of the smart device is lower than 20%, moving image data having the data type code “VIDEO” is disallowable for transmission and a second condition is indicative that if the communication environment of the smart device is unstable, still image data having the data type code “IMAGE” is disallowable for transmission.

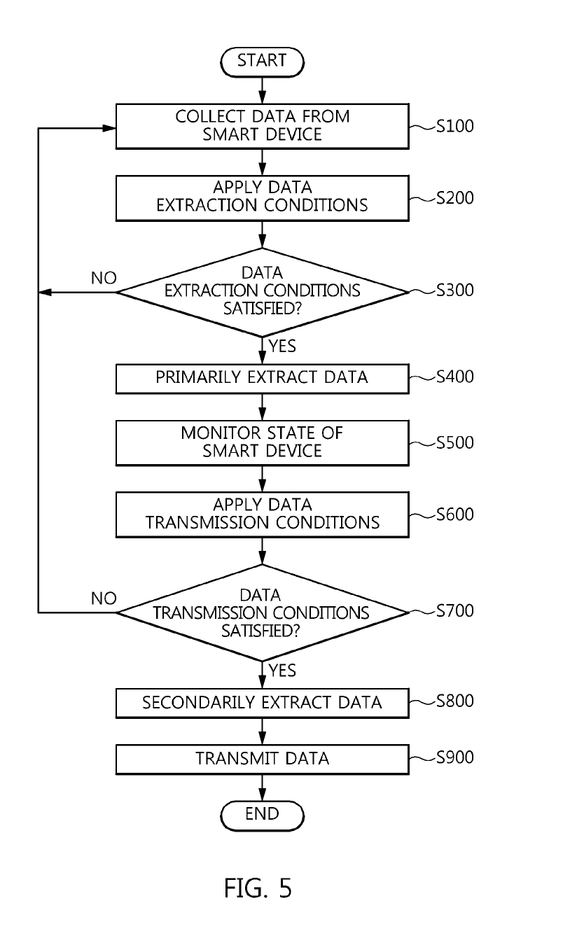

FIG. 5 is a flowchart illustrating a method of transmitting data collected from a smart device according to an embodiment of the present invention.

Referring to FIG. 5, the method of transmitting data collected from a smart device according to this embodiment of the present invention makes use of the previously described device for transmitting data collected from a smart device. Redundant descriptions are omitted.

First, data generated in a smart device is collected at step S100.

Thereafter, data extraction conditions set by the user of the smart device are applied to the collected data at step S200. In this case, the data extraction conditions refer to conditions that are set such that they are used to distinguish between the types of data that are allowable for transmission to the data server and the types of data that are disallowable for transmission to the data server.

Thereafter, it is determined whether the data satisfies the data extraction conditions at step S300. At step S300, the data satisfying the data extraction conditions is data allowable for transmission to the data server, and the data not satisfying the extraction conditions is data disallowable for transmission to the data server.

Thereafter, the data allowable for transmission to the data server is primarily extracted at step S400.

Thereafter, the state of the smart device is monitored at step S500.

Thereafter, at step S600, data transmission conditions previously set by the user of the smart device based on the results of the monitoring are applied to the data extracted at step S400. In this case, the data transmission conditions refer to conditions that are set such that they are used to distinguish between the types of data that can be transmitted to the data server and the types of data that cannot be transmitted to the data server, based on the results of the monitoring.

Thereafter, it is determined whether the data satisfies the data transmission conditions at step S700. At step S700, the data satisfying the data transmission conditions is data that can be transmitted to the data server, and the data not satisfying the data transmission conditions is data that cannot be transmitted to the data server.

Thereafter, data that can be transmitted to the data server is secondarily extracted at step S800.

Finally, the extracted data is transmitted to the data server at step S900.

The apparatus and method for transmitting data collected from a smart device according to embodiments of the present invention extract data from data collected from the smart device based on data extraction conditions and data transmission conditions previously set by a user and transmit only data allowed for transmission by the user to the data server, thereby achieving the advantage of protecting privacy.

Furthermore, the apparatus and method for transmitting data collected from a smart device according to embodiments of the present invention actively control the transmission of data based on the battery level of the smart device or a communication environment, thereby achieving the effect of efficiently transmitting data based on the state of the smart device and thus increasing the lifespan of the battery of the smart device.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A device for transmitting data collected from a smart device, comprising:
a data collection unit configured to collect data generated in a smart device;
a first data extraction unit configured to extract data corresponding to data extraction conditions preset by a user of the smart device from the data collected by the data collection unit;
a monitoring unit configured to monitor a state of the smart device;
a second data extraction unit configured to extract data corresponding to data transmission conditions preset by the user of the smart device based on results of the monitoring of the monitoring unit from the data extracted by the first data extraction unit; and
a data transmission unit configured to transmit data extracted by the second data extraction unit to a data server.

2. The device of claim 1, wherein the data collection unit collects data including at least any one of location data collected via a Global Positioning System (GPS) of the smart device, sensor data collected from a sensor attached to the smart device, still or moving image data collected from a camera module contained in the smart device, voice data, text message data, call record data, address book data, and e-mail data.

3. The device of claim 1, wherein the data extraction conditions are conditions that are set such that they are used to distinguish between types of data that are allowable for transmission to the data server and types of data that are disallowable for transmission to the data server.

4. The device of claim 1, wherein the first data extraction unit extracts data allowable for transmission to the data server by applying the data extraction conditions.

5. The device of claim 1, wherein the monitoring unit monitors a battery level of the smart device and a communication environment.

6. The device of claim 1, wherein the data transmission conditions are conditions that are set such that they are used to distinguish between types of data that can be transmitted to the data server and types of data that cannot be transmitted to the data server, based on results of the monitoring.

7. The device of claim 1, wherein the second data extraction unit, if, as a result of the monitoring, it is determined that a battery level of the smart device is equal to or lower than a preset threshold level or the smart device is in an unstable communication environment, extracts data that can be transmitted to the data server by applying the data transmission conditions.

8. A method of transmitting data collected from a smart device, comprising:
collecting, by a data collection unit, data generated in a smart device;
extracting, by a first data extraction unit, data corresponding to data extraction conditions preset by a user of the smart device from the data collected by the data collection unit;
monitoring, by a monitoring unit, a state of the smart device;
extracting, by a second data extraction unit, data corresponding to data transmission conditions preset by the user of the smart device based on results of the monitoring of the monitoring unit from the data extracted by the first data extraction unit; and
transmitting, by a data transmission unit, data extracted by the second data extraction unit to a data server.

9. The method of claim 8, wherein the data extraction conditions that are used upon extracting the data corresponding to the data extraction conditions preset by the user of the smart device from the data collected by the data collection unit are conditions that are set such that they are used to distinguish between types of data that are allowable for transmission to the data server and types of data that are disallowable for transmission to the data server.

10. The method of claim 8, wherein extracting the data corresponding to the data extraction conditions preset by the user of the smart device from the data collected by the data collection unit comprises extracting data allowable for transmission to the data server by applying the data extraction conditions.

11. The method of claim 8, wherein the data transmission conditions that are used upon extracting the data corresponding to the data transmission conditions preset by the user of the smart device based on the results of the monitoring of the monitoring unit from the data extracted by the first data extraction unit are conditions that are set such that they are used to distinguish between types of data that can be transmitted to the data server and types of data that cannot be transmitted to the data server, based on results of the monitoring.

12. The method of claim 8, wherein extracting the data corresponding to the data transmission conditions preset by the user of the smart device based on the results of the monitoring of the monitoring unit from the data extracted by the first data extraction unit comprises, if, as a result of the monitoring, it is determined that a battery level of the smart device is equal to or lower than a preset threshold level or the smart device is in an unstable communication environment, extracting data that can be transmitted to the data server by applying the data transmission conditions.
